(19) United States
(12) Patent Application Publication
(10) Pub. No.: US 2010/0180778 A1
(43) Pub. Date: Jul. 22, 2010

(54) SLICING DEVICE

(75) Inventors: David H. R. Walker, Tasmania (AU); Matthew Aaron Reeves, Victoria (AU); Simon Lee Andresen, Victoria (AU); Warwick James Brown, Victoria (AU)

Correspondence Address: LERNER, DAVID, LITTENBERG,;KRUMHOLZ & MENTLIK, 600 SOUTH AVENUE WEST, WESTFIELD, NJ, 07090, US

(73) Assignee: David H R Walker and Alison M Walker as trustees for the Vidali Family Trust, Tasmania (AU)

(21) Appl. No.: 12/665,402

(22) PCT Filed: May 30, 2008
(86) PCT No.: PCT/AU08/00758

§ 371 Date: Dec. 18, 2009

(30) Foreign Application Priority Data
Jun. 18, 2007 (AU) 2007903264

(51) Int. Cl. A47J 43/04; B26D 7/06; B26D 7/00; B26D 7/02

(52) U.S. Cl. 99/537; 83/437.2; 83/167; 83/452

(57) ABSTRACT

A food slicing device includes a container for containing a food product for slicing. The container has an open bottom end and is arranged so that a food product can be fed by gravity in a direction towards the bottom end. A movable slicer is provided as well as driving means to move the slicer. Supporting means support the food product contained within the container. The supporting means includes at least two supports, a first of the supports having a fixed position relative to the container and a second of the supports being movable with the slicer. The second support being arranged to slide across a downward facing surface of the food product as the slicer slices through the food product. The supporting means is arranged so that as the slicer slices through the food product, the food product slice can fall away from the food product under gravity.

The present invention relates to a device for slicing a food product, in particular a block of cheese. The invention has been developed principally for that purpose and it will therefore be convenient to describe the invention in relation to that application. However, it is to be appreciated that the invention could be employed to slice other food products, such as fruits and vegetables and therefore is not restricted to use with cheese only.

Retail block cheese is often sold in rectangular blocks up to one kilogram in weight. Typically the block is wrapped for sale in thin film plastic, although sometimes aluminium foil is used instead. When the cheese is to be cut into slices, the packaging or wrapping enclosing the cheese block is removed at least partially from about the block to expose one end of the block. A utensil, such as a sharp knife or cheese slicer, is then employed to cut a slice from the end of the block. Often the cheese block is placed on a plate or chopping board during slicing. In a domestic situation, the cheese block can be unwrapped for slicing by various different family members at different times throughout the day. Thus, the wrapping can deteriorate so that the cheese block is not properly protected against the drying effects of the surrounding air, while a number of utensils, plates and chopping blocks can be dirtied, requiring washing.

Also, because the wrapping is usually easily torn, and is a very close fit about the cheese block, the block is difficult to extract and reinsert into the wrapping. Accordingly, it is often necessary for the block to be re-wrapped in alternative household wrapping that is better able to survive the constant wrapping and unwrapping.

There exists a need for a slicing device suitable to slice food products, in particular cheese, which overcomes or at least alleviates problems or drawbacks associated with the prior art.

According to the present invention there is provided a food slicing device including:
a container for containing at least a portion of a food product for slicing, the container having an open bottom end and being arranged so that a food product can be fed by gravity in a direction towards the bottom end,
a movable slicer for slicing through a bottom end of the food product,
driving means to move the slicer,
supporting means for supporting the weight of a food product contained within the container, the food product being supported at a position in which the slicer can slice through the bottom end of the food product, the supporting means including at least two supports, a first of the supports having a fixed position relative to the container and a second of the supports being movable with the slicer, the second support being arranged to slide across a downward facing surface of the food product as the slicer slices through the food product, the supporting means being arranged so that as the slicer slices through the food product, the food product slice can fall away from the food product under gravity while the food product is supported.

As indicated earlier, the present invention has been developed principally for use with block cheese and therefore, discussion of the invention will principally be made in relation to that application. This should not however be taken as limiting the invention to that application only.

The present invention provides a unique solution to problems or drawbacks associated with the prior art. Firstly, it provides a container which can be arranged to be relatively airtight about a food product during storage, such as in a refrigerator, and thus, a cheese block can be removed from its plastic or foil wrapping and deposited in the container without the requirement to rewrap the cheese block. Moreover, the driving means can be a handle and the handle can be arranged to provide a mechanical advantage, such as a lever ratio of 2:1 so that reduced effort is required by a person using the device compared to use of a knife or cheese slicer in which no mechanical advantage is created. Still further, the device can be arranged so that slices which are sliced from the food product, can fall under gravity to the surface on which the device is supported, or onto a tray which may form part of the device, for later use.

The container preferably defines an interior space for accommodating a food product, which is of square or rectangular cross-section. The container preferably is elongate, although the size and shape of the container can be selected appropriately to suit the type of food product which is to be sliced. In relation to block cheese, these generally are elongate and of square or rectangular cross-section. The interior space of the container preferably provides a snug fit for food products such as cheese, as cheese in particular can deteriorate if left in the open air. Thus, it is preferred that the amount of air to which the cheese block is subjected is minimised. The fit should not however be so snug that there is excessive frictional engagement between the interior walls of the container and the external surfaces of the food product, as that would impede the effect of gravity and therefore possibly prevent the food product from being fed into the position for slicing under the influence of gravity. The snug fit may also only occur about the sides of the food product and not each end, for reasons that will become apparent from later discussion herein.

So that the food product can be fed into position for slicing under the influence of gravity, it is preferred that the container be arranged such as to allow the food product to be fed vertically through the open end of the container. The container alternatively could be inclined, to reduce the effect of the gravity feed. However, it is preferred that the container be elongate and positioned in use, so that the lengthwise axis of the container is generally vertical. It is further preferred that the slicer is movable across the bottom opening of the container, preferably through a generally horizontal plane, for slicing the bottom end of the food product.

It is further preferred that the end of the container opposite the open end is also open and that end typically would be the top end of the container. Thus, the container would have a bottom opening and a top opening. In this arrangement, a removable lid can be employed to close the top opening but conveniently, by removing the lid, the food product can be inserted into or removed from the container.

In a preferred arrangement, the supporting means includes a third support which has a fixed position relative to the container and the third support is spaced apart from the first support in the direction of travel of the slicer through the food product. The third support is provided for weight bearing engagement with a downward facing surface of the food product. By the spaced apart positioning of the first and third supports, the first support can be positioned in a first stage of slicer travel through the food product, while the third support can be positioned in a second stage of slicer travel which is at least half way through the full travel of the slicer through the cheese block. In those positions, the third support is arranged for weight bearing engagement with the food product during the first stage of slicer travel, while the first support is arranged for weight bearing engagement with the food product when the slicer has sliced through a major portion of the food product.

In a preferred arrangement, the first and third supports are disposed at or adjacent opposite ends of the bottom end of the container and are spaced from the bottom end so that the food product extends through the bottom end when it is in weight bearing engagement with the supporting means.

It is preferred that the food slicing device includes a base which rests on a surface on which the device is being used, and which elevates the container above that surface.

It is preferred that the length of the container be greater than the typical length of a food product which will be inserted into the container. Further, it is preferred that the greater length is significant, so that when the major portion of the food product has been sliced and only a small portion of that food product remains to be sliced, a second food product of the same kind can be inserted into the container to bear against the remaining portion of the first food product. In this manner, the weight of the second food product will push against the remaining portion of the first food product so that the first food product continues to be fed properly into the position for slicing under the influence of gravity.

The container is preferably formed from clear or transparent glass or plastic. This enables a user of the slicing device to monitor the amount of food product available for slicing.

Adjacent the open bottom end of the container, a guide arrangement preferably is provided for guiding the slicer in its movement across the bottom end. In one arrangement, the container includes guide rails and these can be arranged to extend from the container adjacent the bottom end thereof. The slicer can be arranged to cooperate with the guide rails and be guided along them during movement across the bottom end of the container. A pair of guide rails can be provided on opposite sides of the bottom end of the container and the guide rails extend generally parallel to each other.

In the preferred arrangement, opposite ends of the slicer can be disposed between a bottom end of the container and a facing surface of the base, or other components of the device, to create a slot within which the ends of the slicer traverse. For example, the base or other component of the device can include a pair of spaced-apart surfaces on which the opposite ends of the slicer can slide, while facing surfaces of the bottom end of the container constrain the slicer against lifting movement away from the spaced-apart surfaces. Slight lifting movement might be tolerated to allow free movement of the slicer along the spaced-apart surfaces.

The slicer can also be arranged to prevent sideways or twisting movement laterally to the direction of slicer travel through the cheese block. The slicer can thus include opposite ends that are configured to cooperate with part of the slicing device and in one form, the slicer includes opposite ends which are formed with openings or channels that accept a guide bar or rail, which guides the slicer against sideways or twisting movement. The guide bar or rail can be a portion of the base or a portion of a seal that projects from the base, or any other suitable component.

It is preferred that the slicing device of the invention includes a tray onto which slices of the food product can fall. In the preferred arrangement, it is preferable that the tray can collect about 10 slices of cheese which have a thickness of about 1.5 mm. In a preferred arrangement, the slicing device of the invention includes a removable tray so that when one or more slices have been received on the tray, the tray can be removed and the food slices removed therefrom. The tray can thus have an operational position in which the tray is positioned to receive slices of cheese, and a dispensing position in which the cheese slices can be removed from the tray. Movement between the operational and dispensing positions preferably is by sliding movement.

In the operational position, the tray can substantially close the bottom end of the container in a relatively airtight manner and in that condition the slicing device can be placed in a refrigerator or cupboard, depending on the type of food product contained within the container thereof, for storage between uses. In one arrangement, seals are employed to engage the bottom end of the container at least during inactive periods when the slicing device is not being used to slice, such as when the device is being stored in a refrigerator, to securely seal the container airtight.

The seals can be movable or deformable as necessary to allow slicing activity. For example, opposite ends of the slicer might extend beyond opposite sides of the container for attachment to a handle for driving the slicer and gaps or slots in the slicing device might therefore be required for the opposite ends of the slicer to extend through. Such gaps or slots will provide a passage or opening for air to enter the container and to spoil the cheese within the container and therefore seals can be employed to close the gaps or slots, at least when the slicing device is not being employed for slicing.

In one arrangement in which the slicing device includes a base, the seals are mounted to the base in a manner permitting movement of the seals between a sealing position, in which the seals seal between the base and the container, and a non-sealing position allowing slicing movement of the slicer. The seal movement to the non-sealing position can be initiated upon commencement of slicing movement of the slicer such that the slicer bears against the seals to displace them out of the path of the slicer. The base can include cavities within which the seals can be movably disposed and biasing means can be employed to bias the seals towards the sealing position.

The slicer can take any suitable form, such as a fine wire, or a blade. The blade can be a straight blade, or a curved or fluted blade. In one preferred form, the slicer has rear and front spaced apart support portions. The rear support portion extends rearwardly of a cutting edge of the slicer while a front support portion extends forwardly of the cutting edge. Preferably the rear and front support portions define an elongate opening between them. In this arrangement, an elongate edge of the opening can be formed as a cutting edge for slicing a food product, and the rear support portion extends rearwardly from that cutting edge. The preference is that the rear and front support portions are spaced apart laterally in the direction of slicer travel, so that the front support portion can engage a downward facing surface of the food product ahead of the cutting edge and the rear support portion can engage a downward facing surface of the food product behind the cutting edge. The length of the opening and the cutting edge should be suitable to exceed the width of the food product being sliced in a direction transverse to the direction of travel of the slicer across the bottom end of the container.

The supports of the slicing device can be arranged so that a food product is not supported by all of the supports during all stages of slicer travel through the food product. Additionally, the manner in which a food product is supported may depend on the extent to which slices have been removed from the food product. For example, in a new cheese block, from which no slices, or very few slices have been removed, the second support may support the weight of the cheese block throughout the full travel of the slicer. As slices are taken from the cheese block and the length of the cheese block is reduced, there is greater potential for the block to tilt within the container and the arrangement might be that upon sufficient tilting movement, one or both of the first and third supports are engaged at stages of slicer travel through the block.

In the preferred arrangement, a slice or slices of food product passes through the elongate opening between the front and rear support portions as it is sliced from the food product.

In the arrangement in which the cutting edge of the slicer is formed as an edge of the rear support portion regardless of whether straight or fluted or otherwise configured, it is preferred that at least part of the rear support portion is angled upwardly relative to the front support portion so that with the slicer extending generally horizontally, the cutting edge is positioned above the front support portion. In this arrangement, prior to initiating a slicing movement of the slicer, the front support portion can be in a position supporting a downward facing surface of the food product. That support can be provided throughout the period in which the food product is not undergoing slicing. In that supporting position, the cutting edge will be positioned slightly above the downward facing surface of the food product which is supported by the front support portion in the position at which it will penetrate the side wall of the food product. The distance that the cutting edge is positioned above the front support portion governs the thickness of the slice that will be produced. Moreover, because at least part of the second rear support portion is provided at an angle relative to the front support portion, the cutting edge will tend to slice into the food product and therefore will not tend to slice out of the food product prior to reaching the opposite side of the food product. Also, because the rear support portion trails the cutting edge, that portion supports the new downward facing surface of the food product once the cutting edge has completely cut through the food product, while the front support portion supports the bottom surface of the food product ahead of the slice during cutting.

The cutting edge can be formed to have converging faces that meet at a point, with one face of the edge being generally horizontal to the surface of the cheese block being cut and the other face extending at an angle downwardly away from that surface. By providing a face which is generally horizontal to the surface of the cheese block being cut, the path through the cheese block can be controlled more easily to be horizontal and to provide for slices of cheese which are of relatively constant thickness.

As indicated earlier, it is preferred that the slicer extends beyond opposite sides of the container laterally to the direction of slicer movement, for connection with a handle. It is preferred that substantially linear movement is imparted to the slicer by rotational movement of the handle. In the preferred arrangement, the slicer includes a pin at either end thereof and each pin is received within an elongate groove in the handle which is shaped to impart the preferred substantially linear slicer movement. The pins traverse along each groove of the handle as it rotates.

A handle for use with the food slicing device of the invention preferably includes a pair of arms which are rotationally connected to opposite sides of the slicing device. The connection can be to the container, or to another part of the device. The arms preferably extend to a gripping portion at one end and to the slicer at the other end. Each arm therefore includes a first section which extends from the gripping portion to a second section which extends to the rotational connection and to the slicer. In this arrangement, the length of the first section can be greater than the length of the second section to obtain a mechanical advantage between the load exerted on the gripping portion compared to that exerted on the slicer. Preferably the mechanical advantage is in a ratio of about 2:1.

The first and third supports can project partly across or below the bottom end of the container for support of the bottom end or surface of a food product placed within the container. These supports do not need to project into the interior space of the container, but can be positioned adjacent the bottom end of the container. Preferably the supports are arranged to support opposite ends or edges of the bottom end of a food product. For example, in one arrangement the first support is provided near the edge of the food product at which the slicer initiates a slice. In this arrangement, the third support can be provided to support the opposite edge of the food product.

As indicated earlier, the first and third supports described above can be provided on a removable base which is removably connected to the container, such as by clamping, adjacent the bottom end thereof. The base can be removable to facilitate disassembly of the food slicing device and to permit more efficient cleaning thereof. The base can be connected to the container by a connector which is fixable to the base and which clamps a flange of the container relative to the base.

A food slicing device according to the invention is simple and easy to operate. The user of the device simply activates a handle to drive the slicer through the food product contained within the container of the device and the slice of food product falls under gravity into a tray, if provided, or onto the surface on which the device is supported. Return movement of the slicer returns the slicer to a position in which a further slice can be cut. In relation to cheese, experiments have shown that a commercial kilo or half kilo block of cheese will remain in good condition for at least two weeks within a close fitting container when refrigerated at 4° Celsius and the container is only required to be washed at the end of each cheese block.

Moreover, no cheese is wasted, or alternatively, it is not required to remove the last portion of a cheese block and slice it manually, because the invention provides for the loading of a second block against the remaining portion of an initial block and the weight of the second block allows that remaining portion to be almost fully sliced.

It has been found that the food slicing device according to the invention, when used with cheese blocks, provides an extremely convenient arrangement for providing cheese slices, and the device can be used by children and adults alike.

For a better understanding of the invention and to show how it may be performed, embodiments thereof will now be described, by way of a non-limiting example only, with reference to the accompanying drawings.

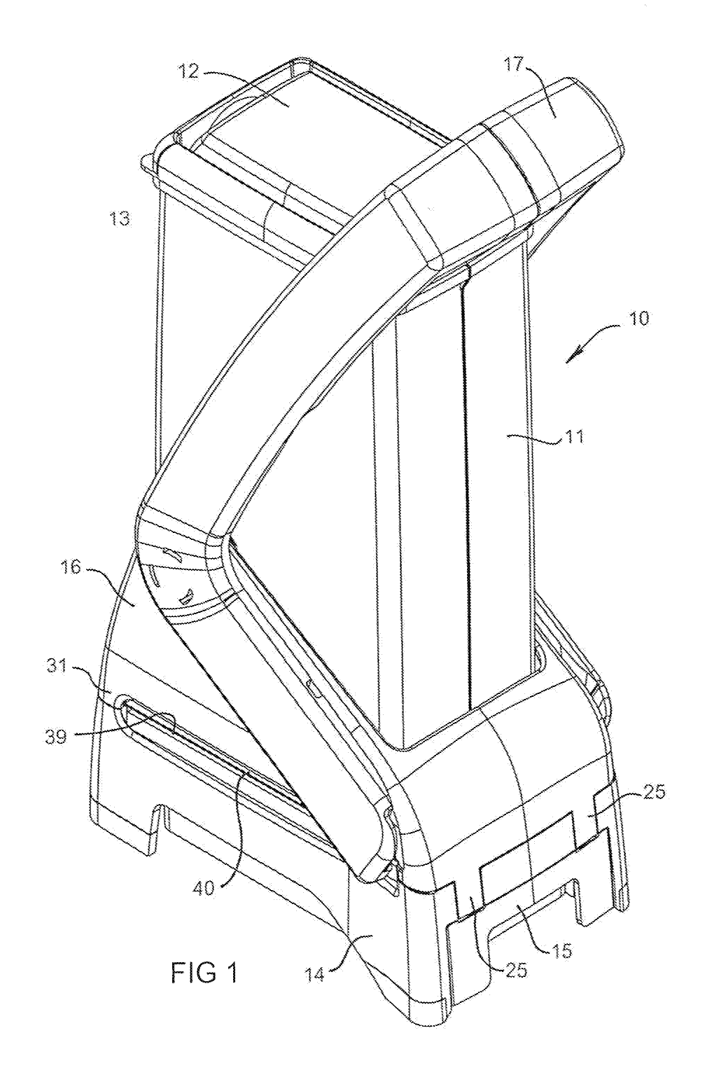

FIG. 1 illustrates a side perspective view of a food slicing device according to the invention.

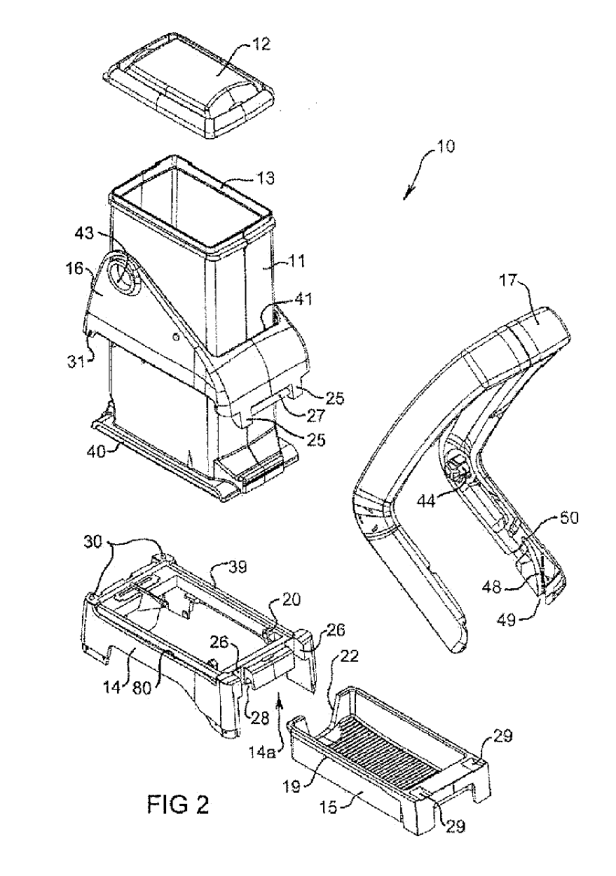

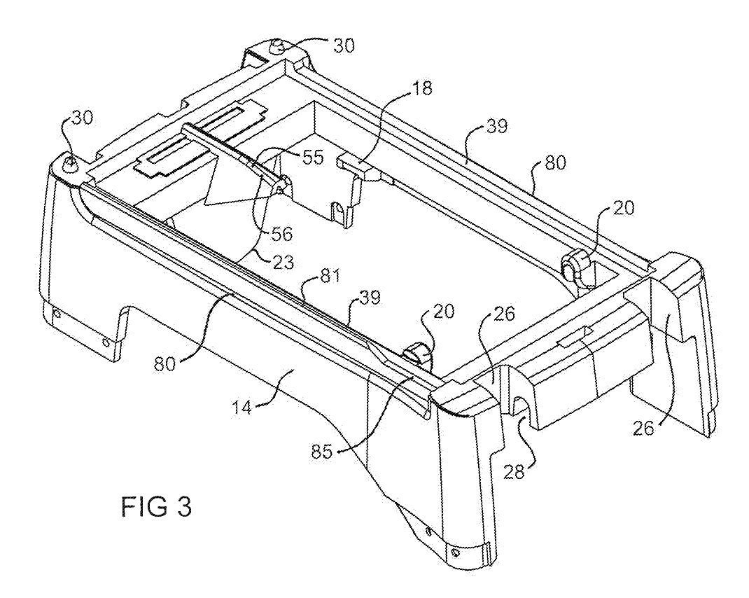

FIG. 2 is an exploded view of some of the parts of the slicing device of FIG. 1.

FIG. 3 is a perspective view of the base of the slicing device of FIG. 1.

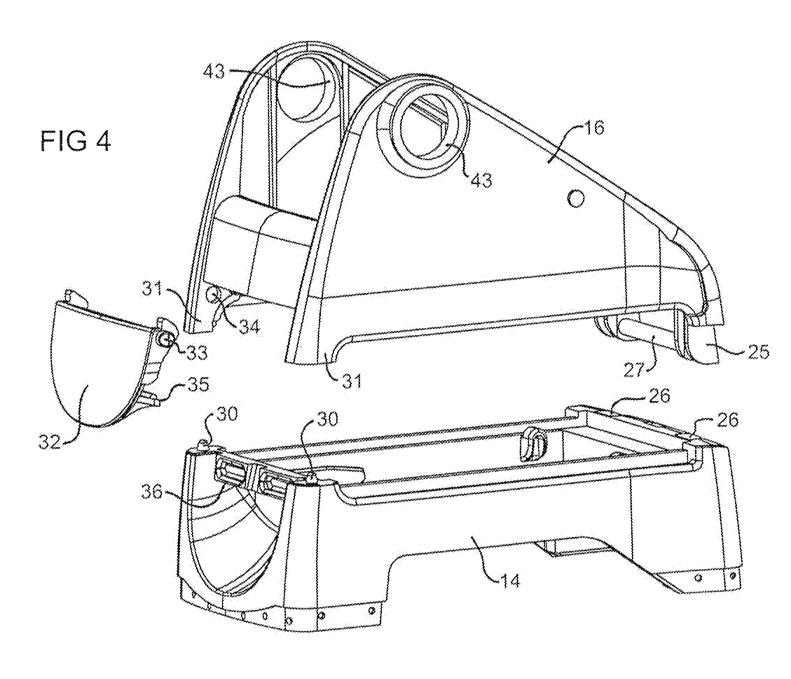

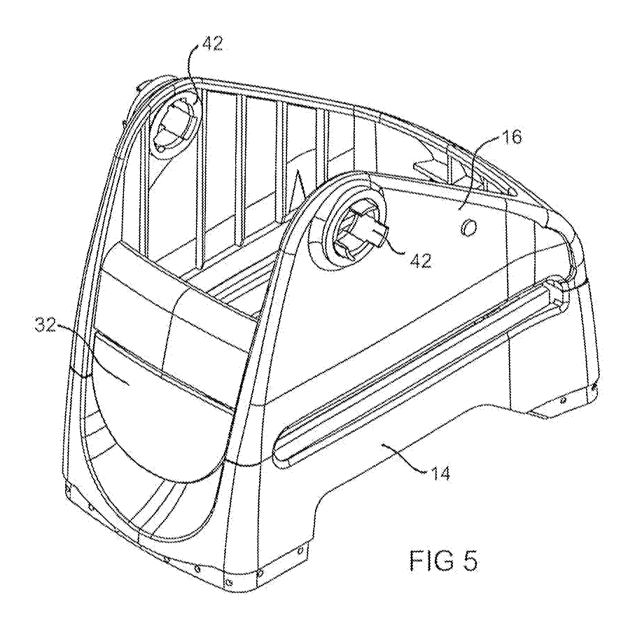

FIG. 4 is an exploded view of the base, connector and latch of FIG. 1.

FIG. 5 is an assembly view of the base, connector, bushes and latch of FIG. 4.

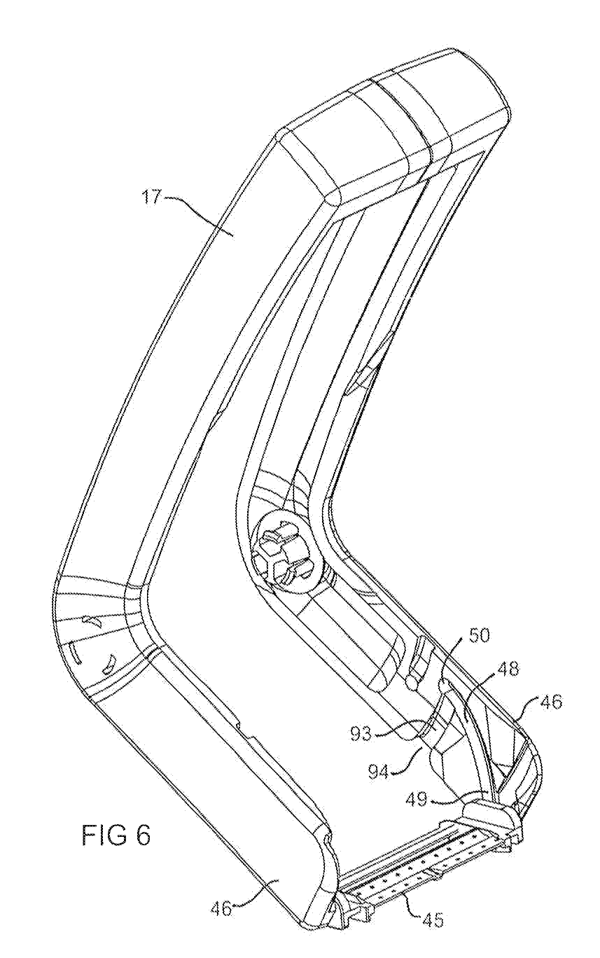

FIG. 6 is a perspective view of the handle of the slicing device of FIG. 1.

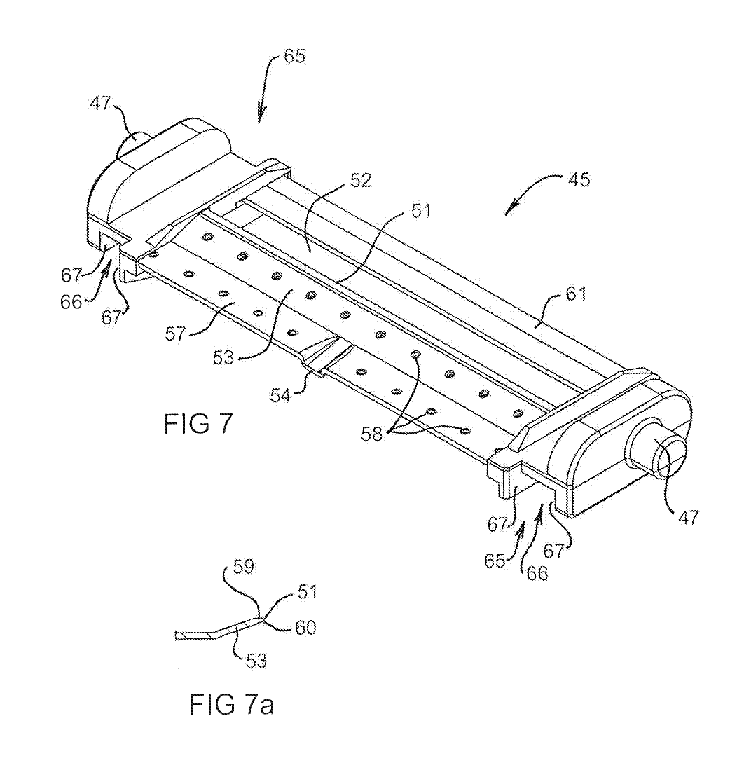

FIG. 7 is a perspective view of the blade of the slicing device of FIG. 1.

FIG. 7a is a side view of the cutting edge of the blade of FIG. 7.

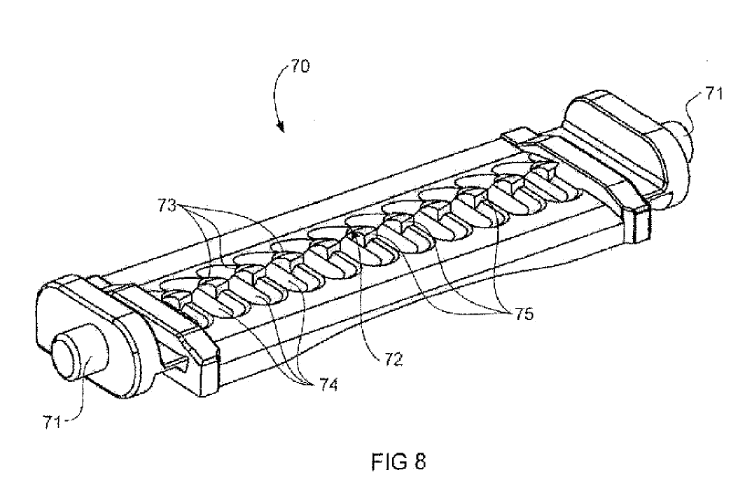

FIG. 8 is a perspective view of a grater for use in the slicing device of FIG. 1

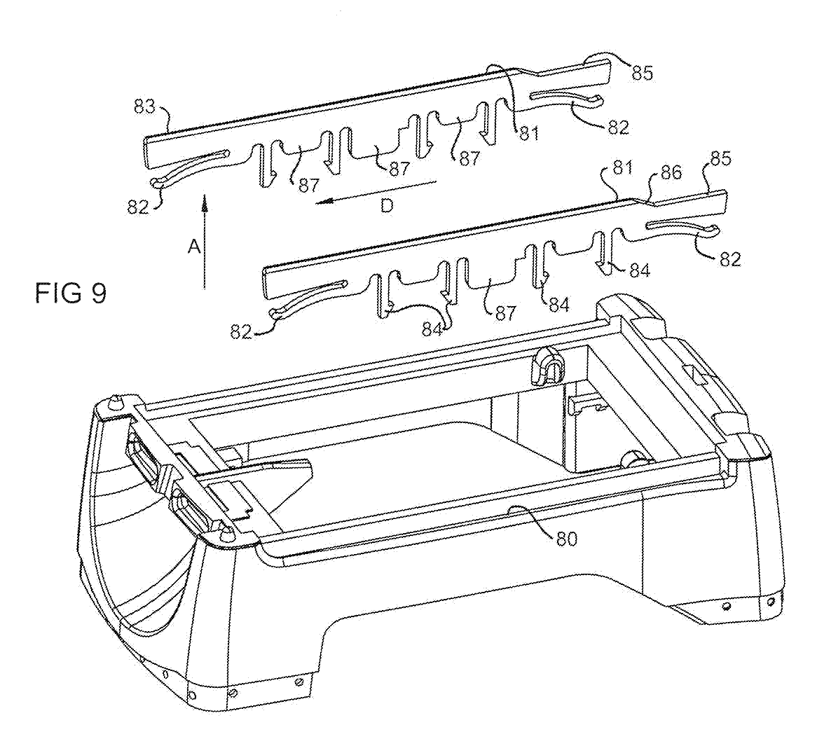

FIG. 9 is an exploded view of the base and seals of the slicing device of FIG. 1.

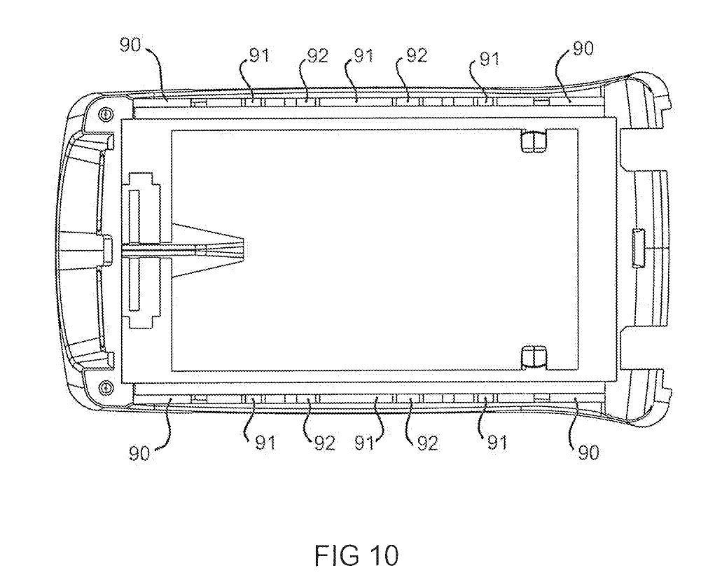

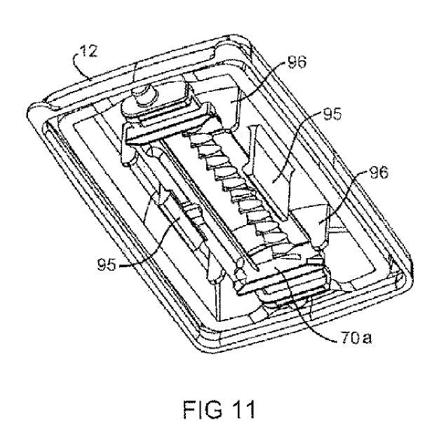

FIG. 10 is a plan view of the base of the slicing device of FIG. 1.

FIG. 11 is a perspective view of the lid and stored grater of the slicing device of FIG. 1.

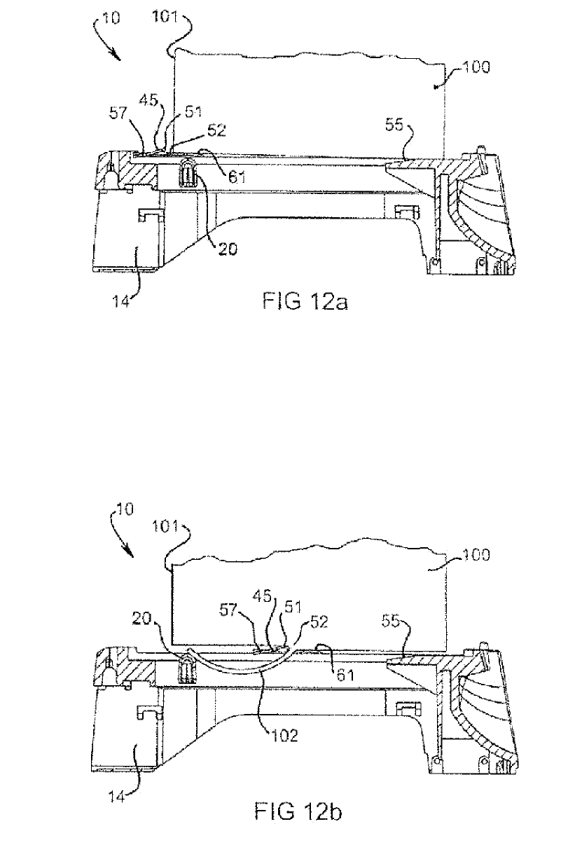

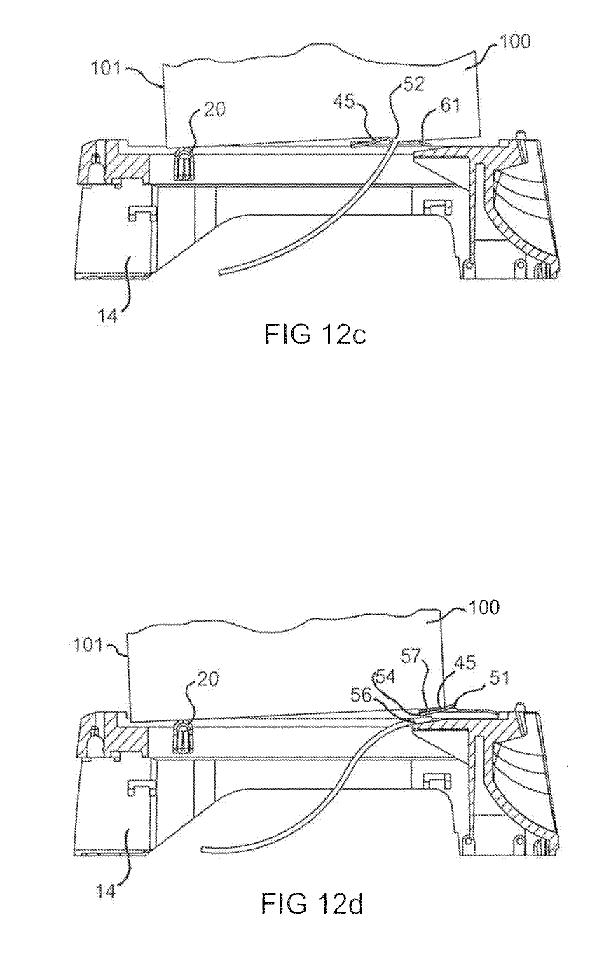

FIGS. 12a to 12d illustrate a sectional view of a bottom portion of the device of FIG. 1 during a slicing operation.

The food slicing device 10 of FIGS. 1 and 2 includes a container 11, which is rectangular in cross-section, and which is arranged for receipt of a block of cheese. The invention has been developed principally for cheese blocks in the region of 500 grams or 1 kilogram, although the container 11 could be arranged to accommodate a block of any suitable size.

The device 10 includes a removable lid 12 which is employed to close an open upper end 13 of the container 11. It is preferred that the lid 12 co-operates with the upper end 13 of the container 11 in a substantially airtight manner.

The device 10 further includes a base 14, a cheese tray 15, a connector 16 and a lever handle 17.

FIG. 3 illustrates the base 14 and shows one of four abutments 18 on which the lip 19 of the tray 15 rests. The tray 15 is slidably supported at each end thereof on the abutments 18. The tray 15 also includes an opening 22 (FIG. 2) which is shaped to receive a tongue 23 (FIG. 3) of the base 14. Receipt of the tongue 23 within the opening 22 occurs as the tray 15 is slid into position in the base 14 through the open end 14a (FIG. 2) of the base 14. The opening 22 facilitates finger access to the interior of the tray 15 to remove slices of cheese, while the tongue 23 closes the opening 22 when the tray 15 is properly inserted into the base 14 to maintain the container 11 of the device 10 substantially airtight. The tray 15 can be removed from the device 10 to gain access to the cheese slices, by sliding movement, reverse to the direction of insertion into the base 14.

Returning to FIGS. 1 and 2, the housing connector 16 includes a pair of downwardly extending projections 25, which are arranged to be received within corresponding recesses 26 formed in the base 14. An axle 27 extends between the projections 25. The axle 27 is arranged for receipt within a downwardly opening recess 28 and permits the connector 16 to pivot relative to the base 14 and the tray 15 as later described herein. The recess 28 is arranged to allow removal of the axle 27 therefrom, but to resist removal. It can be seen in FIG. 2, that the tray 15 includes a pair of recesses 29 to receive the distal end of the projections 25 and it is noted that the recesses 29 are curved complementary to the curved distal ends of the projections 25.

The base 14 further includes a pair of pips 30 which are received in complementary openings formed in the legs 31 of the connector 16. The pips 30 locate the legs 31, but otherwise have no retaining function. The end of the connector 16 adjacent the pips 30 is fixed relative to the base 14 by a latch 32, which is shown in exploded view relative to the base 14 and the connector 16 in FIG. 4. In FIG. 4, it can be seen that the latch 32 includes spigots 33 (there is one on each side of the latch 32, although only one spigot 33 is illustrated in FIG. 4), which are arranged to be received within openings 34 formed on the inside surface of each of the legs 31 of the connector 16. By receipt of the spigots 33 in the openings 34, the latch 32 is rotatable into a position in which the latching member 35 engages underneath a ledge 36 formed on the base 14. Engagement between the latching member 35 and the ledge 36 is operable to lock the connector 16 in place relative to the base 14, at the end of the connector 16 at which the legs 31 are provided. The latching member 35 is latched to the ledge 36 following receipt of the axle 27 within the recess 28.

Before the connector 16 is fixed to the base 14 in the manner discussed above, the bottom flange 40 of the container 11 is sandwiched between the base 14 and the connector 16. The flange 40 is evident in FIG. 1 and sandwiching occurs by feeding the container 11 through the underside of the central opening 41 (see FIG. 2), before the connector 16 is connected to the base 14. Thus, before the connector 16 is fixed to the base 14, the container 11 is fed through the opening 41. Thereafter, the axle 27 of the connector 16 is positioned within the recess 28 of the base 14 and the latch 32 is pivoted to engage the latching member 35 beneath the ledge 36. By that arrangement, each of the container 11, the base 14 and the connector 16 are securely connected together.

The lever handle 17 is pivotally connected to the connector 16 through a pair of bushes 42 (FIG. 5), which are fitted into openings 43 (FIGS. 2 and 4) of the connector 16. The lever handle 17 includes connectors 44 which mate with the bushes 42 and which provide a point for pivoting of the handle 17 relative to the connector 16. The mating arrangement between the handle 17 and the connector 16 can take any suitable form.

In FIG. 6, a slicer in the form of a blade 45 is shown connected to bottom end regions 46 of the handle 17. The blade 45 is shown in detail in FIG. 7.

The blade 45 includes pins 47 for receipt within respective cam grooves 48 of the handle 17. The cam grooves 48 are each curved and allow the blade 45 to traverse horizontally along the upper surface 39 (FIGS. 2 and 3) of the base 14. The upper surface 39 can be a surface of the base 14 or of a seal 81 which projects from the base 14, or a combination of both. In FIG. 3, a single seal 81 is illustrated, however, if seals are provided, two seals would be provided as shown in FIG. 9. Thus, as the lever handle 17 is rotated clockwise from the position shown in FIG. 1, the blade 45 traverses horizontally from one end of the base 14 to the other, while the pins 47 traverse through the cam grooves 48, from adjacent the open end 49 of the grooves, to the opposite and distal end 50.

The blade 45 includes a cutting edge 51 which forms one edge of an elongate opening 52 through which a slice of cheese passes as slicing takes place. The cutting edge 51 is elevated above other parts of the blade 45 through a ramp section 53. The blade 45 includes a downwardly projecting portion 54 that is arranged to engage with a support 55 (FIG. 3), to apply a light clamping load to a cheese slice as it is released from the cheese block during a slicing stroke, to cause the slice to lightly stick to the distal end 56 of the support 55 so as to prevent the slice from re-entering the opening 52 of the blade 45. Thus, the distal end 56 of the support 55 is inclined downwardly at substantially the same angle as the portion 54 extends downwardly away from the plane of the rear blade support portion 57.

The blade 45 further includes a plurality of downwardly projecting dimples 58 which are provided to prevent the cheese slice from sticking to the underside of the blade 45 after it has been sliced. The cutting edge 51 of the blade 45 is illustrated in FIG. 7A as having a top edge 59 that is formed to be parallel to the surface of the cheese block it is arranged to slice and by that horizontal formation, the horizontal path through the cheese block can be controlled more easily. The bottom edge 60 can be formed at any suitable angle.

The blade 45 is comprised of a stainless steel main portion and plastic end portions that are fixed to the main portion. Thus, the ramp section, the rear blade support portion 57 and the front support portion 61 (which is described later herein) are all stainless steel, while the end portions 65 are plastic moulded portions. It is possible however, that the entire blade could be formed from steel or plastic.

It has been described earlier, that the pins 47 are received within the cam grooves 48 and that the blade 45 slides along the surface 39 (FIGS. 2 and 3) of the base 14. In relation to the blade 45, it is further the case that the blade 45 is positioned between the base 14 and the bottom flange 40 of the container 11 (See FIGS. 1 and 2) and includes end portions 65 which are configured to cooperate with the base 14 and/or the seals 81 which project from the base 14, and/or the bottom flange 40 of the container 11. Any suitable cooperating arrangement can be adopted. In FIG. 7, the end portions 65 include channels 66 which have vertical walls 67. The vertical walls 67 sit on either side of the surface 39 of the base 14 and by that arrangement, the blade 45 is prevented from sideways or twisting movement laterally to the direction of slicer travel during a slicing stroke. By this arrangement, the blade 45 is also constrained substantially against lifting or falling.

The device 10 can be used with the blade 45 as shown in FIG. 7, or it can be used with other slicing implements, such as the grater 70 illustrated in FIG. 8. The grater 70 is of the same construction as the blade 45 except it does not have an elongate slot 52, and in relation to the cutting edge 72, the edge is fluted rather than straight. The cutting edge 72 is formed in a series of semi-circular flutes 73, each of which forms the front edge of a passageway 74 that extends rearwardly from the flutes in the opposite direction to travel of the grater 70 through a cheese block. Each passage 74 is separate from each other passage 74. The grater 70 produces grated cheese, rather than a slice of cheese as is produced by the blade 45.

A portion 75 of the cutting edge 72 ensures that a complete layer of cheese is removed from the bottom of the cheese block 100 each time the grater 70 is driven to cut through the bottom end of a cheese block.

In other respects, the grater 70 is mounted in the device 10 in the same manner as the blade 45 and is therefore displaceable via the lever handle 17 in the same way as previously described in relation to the blade 45.

Seals 81 are provided in the device 10 in cavities formed in the base 14. The seals 81 can be of any suitable material, such as plastic or rubber. With reference to FIG. 3, cavities are formed in the region 80 on each side of the base 14 to accept a seal 81. FIG. 9 is an exploded view of the base 14 and the pair of seals 81 which would be received in cavities formed in the regions 80 of the base 14. FIG. 10 is a plan view of the base 14 in order to show the cavities.

Referring to FIG. 9, it can be seen that each of the seals 81 includes a resilient spring 82 at each end thereof and each spring 82 is arranged to bear against an internal surface 90 of the cavity in which the seal is placed, in order to provide lifting movement of the seal 81 in the direction A. The amount of lift that the springs 82 provide is such as to lift the upper edge 83 of the seals 81 into engagement with the facing surface of the bottom flange 40 of the container 11. The springs lift the seals 81 when the device 10 is in the pre-slicing position of FIG. 1. In that position, the blade 45 (or the grater 70) is positioned in the recessed portion 85 of the seals 81, in which there is no resistance to lifting movement by the blade 45 on the seals 81. With each of the seals 81 in the lifted position, the seals 81 substantially close any air gaps which might otherwise be present between the bottom flange 40 and the base 14.

In order to prevent the seals 81 from lifting out of the cavities in which they are housed, each seal 81 includes a plurality of legs 84 which include end barbs at the distal ends thereof and the barbs are arranged to engage underneath surfaces within the cavities when maximum lifting movement of the seals is achieved. Thus, upon maximum lifting movement, the barbs prevent the seals from lifting any further. This prevents inadvertent removal of the seals from the cavities.

Upon rotation of the lever handle 17, the blade 45 moves in the direction D (FIG. 9) and thus applies pressure to the ramp section 86 of each seal 81 and by that pressure, the blade 45 pushes the seals 81 downwards. That downward movement of the seals 81 is against the biasing influence of the springs 82, while the legs 84 are free to move downwardly within the cavities. A plurality of guiding members 87 guide the seals 81 within the cavities during upward and downward movement of the seals 81.

FIG. 9 shows the cavities into which the seals 81 are positioned. The cavities comprise a spring seating portion 90 in which the springs 82 are positioned and the portion 90 includes a surface against which the springs 82 bear. The cavities further comprise a plurality of leg cavities 91 which receive the legs 84 of the seals 81, while bridging portions 92 extend across the cavity and provide surfaces for engagement by the end barbs of the legs 84. The seals thus move upwardly and downwardly within the cavities under the biasing influence of the springs 82 as the blade 45 is driven across the base 14.

Returning to the lever handle 17, and to FIG. 6, an entry groove 93 is illustrated, and it is the entry groove 93 which facilitates loading of the blade 45 or the grater 70 or any other suitable implement in the device 10. It is to be noted that the device 10 can include a storage facility for storing a blade, grater or other suitable implement, so that the user of the device 10 can select either to slice or grate or otherwise process cheese. In the device 10, storage can be in the manner shown in FIG. 11, in which the grater 70 is held by a pair of clips 95 against a pair of lugs 96.

Returning to FIG. 6, to connect a blade into the device 10, the blade 45 is positioned so that the pins 47 are aligned with the open end 94 of an entry groove 93. With the pins 47 aligned with the opening 94, the handle 17 can be rotated clockwise, with the effect that the pins 47 will ride into and upwardly of the entry groove 93. The groove 93 reduces in depth from the opening 94 to its junction with the cam groove 48 and the effect of that depth reduction, is to cause the ends of the handle 17 adjacent the entry groove 93, to resiliently displace outwardly, progressively more as the pins 47 move towards the cam groove 48. As the pins 47 move from the entry groove 93 into the cam groove 48, the ends of the handle 17 return to their pre-displaced position (they would snap back) and the blade is now connected to the handle 17.

Removal of the blade 45 can be achieved by unlatching of the base 14 from its clamped position with the connector 16 as earlier described, by release of the latch 32 and by pivoting the connector 16 about the axle 27. Thereafter, the pins 47 of the blade 45 can be slid through the cam groove 48 and out of the open end 49 of the groove 48.

With the device 10 assembled as described above, the lid 12 can be removed and a cheese block can be inserted into the container 11. The lid is thereafter returned to close the upper end 13 of the container 11.

FIGS. 12a to 12d show a sectioned view of part of the bottom portion of the slicing device 10 during a slicing operation. For clarity purposes only, most of the parts of the device 10 described previously are omitted from FIGS. 12a to 12d. In particular, the handle 17 is omitted, but it will be appreciated that the handle 17 as shown in FIG. 1, is rotated in a clockwise direction to move the blade 45 across the base 14, in order to cut a slice from a cheese block positioned within the container 11 of the device 10.

Referring to FIG. 12a, this shows the blade 45 in a pre-slicing or starting position, such that the handle 17 is in the position shown in FIG. 1. In that figure, it can be seen that the cheese block 100 is supported at the leading end thereof by a front support portion 61 of the blade 45. The trailing end of the cheese block 100 is supported by the support 55. The supporting lugs 20 of the base 14 have no contact with the cheese block 100 at this stage. Thus, in this position, the cheese block 100 is supported by the front support portion 61 at one end and by the support 55 at the other end. It can also be seen that the cheese block 100 is tilted slightly in the FIG. 12a position toward the support 55, and this is because it is supported slightly higher by the front support portion 61 than by the support 55.

FIG. 12b shows an advanced position of the blade 45 in which the handle 17 has been rotated to bring the cutting edge 51 of the blade 45 through the side wall 101 of the cheese block 100 so as to commence slicing of the blade 45 through the block 100. It can be seen that the initial portion of a cheese slice 102 which has been sliced from the bottom of the cheese block 100, is fed through the opening 52 of the blade 45 between the front and rear support portions 61 and 57. It can also be seen that the cheese block 100 has tilted away from its initial position shown in FIG. 12a and is no longer in contact with the support 55. Rather, the cheese block 100 in FIG. 12b is fully supported by the front support portion 61 of the blade 45. However, FIG. 12b illustrates that the portion of the slice 102 that has been cut from the cheese block 100 rests at one end on the supporting lugs 20.

FIG. 12c shows the blade 45 approaching the opposite or trailing end of the cheese block 100 from which it commenced slicing. The cheese block 100 is now supported at one end on the supporting lugs 20 and at the opposite end by the front support portion 61 of the blade 45. Moreover, the flexibility of the slice 102 and the increased length and weight of that slice, has caused it to fall past the supporting lugs 20 under the influence of gravity. The slice 102 is now partly resting in the tray 15, although the tray 15 is not visible in the sectioned view of FIG. 12c. The cheese block 100 has also tilted in the opposite direction to that shown in FIG. 12a.

FIG. 12d shows the final travel of the blade 45 in a slicing stroke through the cheese block 100. The cutting edge 51 of the blade 45 has passed fully through the cheese block 100 and thus, the cheese slice 102 is fully cut from the cheese block 100. It can be seen in this figure that the end of the cheese block 100 from which the slicing stroke commenced, is resting on and is supported by the supporting lugs 20. The cheese block 100 is supported at the other opposite end by the rear blade support portion 57. Moreover, the cheese block 100 remains tilted slightly in the opposite direction from the tilt which is illustrated in FIG. 12a.

In the position shown in FIG. 12d, the last portion of the slice 102 which has been cut from the cheese block 100 is lightly sandwiched between the portion 54 (FIG. 7) of the blade 45 and the facing surface of the distal end 56 (FIG. 3) of the support 55. This tends to cause the slice 102 to lightly adhere or stick to the support 55, so that when the handle 17 is rotated in the reverse direction to return the blade 45 to the leading end of the cheese block 100 to initiate cutting of a new cheese slice, the slice 102 does not re-enter the opening 52 of the blade 45.

Return movement of the blade 45 shifts the slice 102 relative to the support 55 in the direction of the return movement. Thus, the slice 102 is shifted away from support by the support 55 and is thereafter free to fall under gravity into the tray 15. As indicated above, the slight sandwiching load between the portion 54 of the blade 45 and the facing surface of the distal end 56 of the support 55 prevents the slice from re-entering the opening 52 of the blade 45 as the blade 45 returns to the leading end of the cheese block 100. Instead, the sandwiching load causes the slice 102 to lightly stick to the distal end 56 of the support 55 until the opening 52 has passed.

As the handle 17 is rotated back to the position shown in FIG. 1, the supporting arrangements which support the cheese block 100, change from the arrangement of FIG. 12d, so that gradually the cheese block 100 is lifted away from the supporting lugs 20 and into support by the front support portion 61 of the blade 45 and by the support 55. Thus, the cheese block 100 is returned to the position at which it is supported with the cutting edge 51 of the blade 45 positioned ready for cutting a new slice of cheese from the cheese block 100.

Once the desired number of slices has been cut, or the maximum number of slices that the tray 15 can hold has been cut, the tray 15 can be removed from the device 10 by sliding it out of the base 14 relative to the abutments 18. The cheese slices can then be removed and the tray 15 replaced.

Advantageously, the tray 15 can be employed to close the bottom end of the slicing device 10 in an airtight manner and so minimise spoiling of the cheese due to exposure to air. Thus with the tray 15 in the position shown in FIG. 1, the container is closed at the top end by the lid 12 and at the bottom end by the seals 81 and the tray 15. The device 10 can be stored in this manner, for example in a refrigerator or cupboard, without the cheese deteriorating.

It will be appreciated that the slicing device 10 as illustrated is a simple device to operate, but it also provides further advantages by way of needing limited cleaning, while it additionally maintains the cheese block 100 in an environment that minimises deterioration, such as drying out. The container 11 is sized to relatively snugly fit the cheese block 100 so that there is only limited space for air to surround the block and the cheese block is only exposed at the bottom end thereof to external air for the duration of a slicing operation.

It will also be appreciated that the slicing device 10 relies on gravity to feed the cheese block 100 downwardly and into engagement with the blade 45. The use of gravity minimises the effort required to operate the slicing device 10 and thus all that is required is for the operator to rotate the handle 17 in the required direction to produce the slice and to rotate it in the opposite direction to return it for cutting of a new slice. The use of gravity also minimises the components of the device 10, as there is no requirement for similar arrangements of the prior art which employ springs and biasing devices to maintain the cheese block in engagement with the blade.

1-27. (canceled)

28. A food slicing device comprising:
a container for containing at least a portion of a food product for slicing, the container having an open bottom end and being arranged so that a food product can be fed by gravity in a direction towards the bottom end,
a movable slicer for slicing through a bottom end of the food product,
driving means to move the slicer,
supporting means for supporting the weight of a food product contained within the container, the food product being supported at a position in which the slicer can slice through the bottom end of the food product, the supporting means including at least two supports, a first of the supports having a fixed position relative to the container and a second of the supports being movable with the slicer, the second support being arranged to slide across a downward facing surface of the food product as the slicer slices through the food product, the supporting means being arranged so that as the slicer slices through the food product, the food product slice can fall away from the food product under gravity while the food product is supported.

29. The food slicing device according to claim 28, wherein the slicer is movable across the open bottom end of the container.

30. The food slicing device according to claim 28, wherein the supporting means includes a third support having a fixed position relative to the container and the first and third supports being spaced apart in the direction of travel of the slicer through the food product for weight bearing engagement with a downward facing surface of the food product, the first support being positioned in a first stage of slicer travel through the food product and the third support being positioned in a second stage of slicer travel which is at least half way through full travel of the slicer through the food product, the arrangement being such that the third support is arranged for weight bearing engagement with a downward facing surface of the food product during the first stage of slicer travel and the first support is arranged for weight bearing engagement with a downward facing surface of the food product when the slicer has sliced through a major portion of the food product.

31. The food slicing device according to claim 30, wherein the first and third supports are disposed at or adjacent opposite ends of the bottom end of the container, and spaced from the bottom end, so that the food product extends through the bottom end when it is in weight bearing engagement with the supporting means.

32. The food slicing device according to claim 30, wherein the first and third supports are arranged such that the food product slice falls past the first support in the first stage of slicer travel and falls past the third support when the slicer has completed slicing through the food product and is being driven by the driving means to return for slicing of a new food product slice.

33. The food slicing device according to claim 28, wherein the second support is formed as part of the slicer and includes a rear support portion which extends rearwardly of a cutting edge of the slicer and a front support portion which extends forwardly of the cutting edge, the rear and front support portions being spaced apart laterally of the direction of slicer travel so that the front support portion can engage a downward facing surface of the food product ahead of the cutting edge and the rear support portion can engage a downward facing surface of the food product behind the cutting edge.

34. The food slicing device according to claim 33, wherein the weight of the food product is supported by any one or more of the first, second and third supports during different stages of slicer travel through the food product.

35. The food slicing device according to claim 28, wherein the first support includes a pair of facing supports which project towards each other from proximate opposite edges of the open end.

36. The food slicing device according claim 30, wherein the second support lifts the bottom end of the food product from support by the third support in the second stage of slicer travel.

37. The food slicing device according to claim 30, wherein the second support is operable to tilt the food product within the container so that during the first stage of slicer travel, the bottom end of the food product is lifted from the support of the first support and is lowered into the support of the third support.

38. The food slicing device according to claim 30, wherein the second support is operable to tilt the food product within the container so that during the second stage of slicer travel, the bottom end of the food product is lifted from the support of the third support and is lowered into the support of the first support.

39. The food slicing device according to claim 28, wherein the container is arranged so that a slice of the food product falls vertically away from the food product upon completion of movement of the slicer through the food product.

40. The food slicing device according to claim 28, further including a removable tray onto which the slice of food product can fall.

41. The food slicing device according to claim 40, wherein the tray substantially closes the bottom end of the container when positioned to receive a slice of food product.

42. The food slicing device according to claim 33, wherein the cutting edge is formed as an edge of the rear support section and the rear support section is angled upwardly relative to the front support section, so that with the slicer extending generally horizontally, the cutting edge is positioned above the front support section.

43. The food slicing device according to claim 33, wherein the rear support portion of the slicer includes a projecting portion that cooperates with the third support to clamp an end of the food slice when the slicer has completed slicing through the food product.

44. The food slicing device according to claim 43, wherein by clamping the end of the food slice to the third support when the slicer has completed slicing through the food product, the clamped portion of the food slice can adhere lightly and releasably to the third support so that as the slicer is initially driven by the driving means to return for slicing of a new food product slice, the food slice is held stationary relative to the slicer.

45. The food slicing device according to claim 33, wherein a plurality of relatively short projections extend from the underside of the slicer adjacent the cutting edge and from the underside of the rear support portion to prevent the food product from adhering to those parts of the slicer.

46. The food slicing device according to claim 33, wherein the cutting edge of the slicer is formed to have first and second converging faces that meet at a point, with the first face of the cutting edge being generally horizontal to the surface of the cheese block being cut and the second converging face extends at an angle downwardly away from the first face.

47. The food slicing device according to claim 28, wherein the container has a storage condition in which it is substantially airtight.
